(19) United States
(12) Patent Application Publication
(10) Pub. No.: US 2026/0037107 A1
(43) Pub. Date: Feb. 5, 2026

(54) DISPLAY VIDEOS ASSOCIATED WITH AUDIO ON PROFILE PAGE

(71) Applicant: Lemon Inc., Grand Cayman (KY)

(72) Inventor: Parth Vijay Sinha, New Delhi (IN)

(21) Appl. No.: 18/872,727

(22) PCT Filed: May 24, 2023
(86) PCT No.: PCT/SG2023/050360

§ 371 Date: Dec. 6, 2024

(30) Foreign Application Priority Data
Jun. 10, 2022 (IN) 202221033382

(51) Int. Cl. G06F 3/0484; G06F 3/0482

(52) U.S. Cl. CPC G06F 3/0484; G06F 3/0482

(57) ABSTRACT

In embodiments of the present disclosure, there is provided an approach for displaying videos pinned with an audio on a profile page. A video and a name of a second user who generates a background audio of the video are displayed to a first user. The name of the second user may indicate a link to a profile page of the second user. And then, a detecting of a user input is continuously performed. If a user selection to the name from the first user is detected, the profile page of the second user is displayed to the first user. The profile page may at least include an audio and a predetermined number of videos associated with the audio.

### CROSS-REFERENCE TO RELATED APPLICATION

This application claims priority to IN Application No. 202221033382, entitled DISPLAY VIDEOS ASSOCIATED WITH AUDIO ON PROFILE PAGE, filed on Jun. 10, 2022, the entire contents of that application being incorporated herein by reference in its entirety.

### BACKGROUND

The video social application is so powerful that any user (e.g. artist) can upload his own videos as a user of the application for other users to watch. So, being featured in the most followed videos may be the dream of many up-and-coming artists. The interactivity of the video social application enhances the user experience. However, the audio or music tab on the user profile page is less interactive. Accordingly, there is a need to identify and utilize low cost yet effective ways to improve the interactivity of the video social application.

### SUMMARY

In accordance with examples of the present disclosure, a low cost yet effective way to improve the interactivity of the video social application is described. In examples, a video pinning solution can mine preference information on user (e.g. artist) side to increase the degree of interaction between users of the video social application.

Thus, in accordance with examples of the present disclosure, a computer-implemented method for pinning videos is described. The method may include displaying, to a first user, a video and a name of a second user who generates a background audio of the video, the name indicates a link to a profile page of the second user. The method may further include in response to receiving a user selection to the name from the first user, displaying the profile page of the second user to the first user, wherein the profile page at least includes an audio and a predetermined number of videos associated with the audio.

In accordance with examples of the present disclosure, an electronic device is described. The system may include a processing unit and a memory coupled to the processing unit and storing instructions thereon. These instructions, when executed by the processing unit, perform acts comprising: displaying, to a first user, a video and a name of a second user who generates a background audio of the video, wherein the name indicates a link to a profile page of the second user. The acts further comprises in response to receiving a user selection to the name from the first user, displaying the profile page of the second user to the first user, wherein the profile page at least includes an audio and a predetermined number of videos associated with the audio.

In accordance with examples of the present disclosure, a computer program product stored in a non-transitory computer storage medium and comprises machine-executable instructions is described. In examples, when executed on a device, the instructions cause the device to perform acts comprising displaying, to a first user, a video and a name of a second user who generates a background audio of the video, wherein the name indicates a link to a profile page of the second user. The acts further comprise in response to receiving a user selection to the name from the first user, displaying the profile page of the second user to the first user, wherein the profile page at least includes an audio and a predetermined number of videos associated with the audio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will be made more apparent by describing the present disclosure in more detail with reference to drawings. In the drawings, the same or like reference signs represent the same or like elements, wherein,

FIG. 1 illustrates a schematic diagram of an example environment according to an embodiment of the present disclosure;

FIG. 2 illustrates a flowchart of a process for displaying a profile page according to an embodiment of the present disclosure;

FIGS. 3A-3D respectively illustrate schematic diagrams of a plurality of states of a user interface of a video social application according to an embodiment of the present disclosure;

FIG. 4 illustrates a flowchart of a process in which a video selected by a user (e.g. an artist) is pinned to audio uploaded by the user, according to an embodiment of the present disclosure;

FIG. 5 illustrates a schematic diagram of a user interface for a user (e.g. an artist) to perform an audio-video pinning operation according to an embodiment of the present disclosure;

FIG. 6 illustrates a schematic diagram of a user interface for a user (e.g. an artist) to perform an audio-video pinning operation by copying a video link, according to an embodiment of the present disclosure; and

FIG. 7 illustrates a schematic block diagram of an example device that may be used to implement an embodiment of the present disclosure.

### DETAILED DESCRIPTION OF EMBODIMENTS

Embodiments of the present disclosure will be described in more detail below with reference to figures. Although the drawings show some embodiments of the present disclosure, it should be appreciated that the present disclosure may be implemented in many forms and the present disclosure should not be understood as being limited to embodiments illustrated herein. On the contrary, these embodiments are provided herein to enable more thorough and complete understanding of the present disclosure. It should be appreciated that drawing and embodiments of the present disclosure are only used for exemplary purposes and not used to limit the protection scope of the present disclosure.

As used herein, the term “includes” and its variants are to be read as open terms that mean “includes, but is not limited to.” The term “based on” is to be read as “based at least in part on.” The term “an embodiment” is to be read as “at least one embodiment.” The term “another embodiment” is to be read as “at least one other embodiment.” The term “some embodiments” is to be read as “at least some embodiments.” Definitions of other terms will be given in the text below.

The video social application mentioned herein is application software mainly used to provide users with functions such as video editing, producing, viewing, and interacting. The video mentioned herein may be a short video of only ten or tens of seconds in length or video clips of other different lengths, and the audio mentioned herein may be music, song, or clip thereof. In addition, the user may watch videos played on the video social application as a viewer (hereinafter also referred to as “the first user”), and the user may also produce and upload videos on the video social application as an artist (hereinafter also referred to as “the second user”). It should be understood that videos produced by an artist usually include one or more audios produced and uploaded by other artists.

When the first user watches a video, traditional video social applications do not display the creator of the audio of the video, i.e. name (or ID) of the second user. At this point, the first user may touch or click on the name of the second user to access the profile page of the second user. As discussed above, traditional video social applications generally suffer from the following problems.

The profile page of the second user displayed by the traditional video social application only involves one or more audios created or uploaded by the second user, and the first user may only discover, appreciate, comment, or like one or more of these audio. The first user cannot further interact with the second user by discovering the preferences of the second user.

In addition, the setting authority of the second user in his/her profile page is still low. As mentioned above, traditional profile pages are only used to present video or audio created or uploaded by the second user. However, the second user cannot express preferences for his/her or others' audio or video by personalizing the profile page.

In order to at least partially address the above disadvantages, embodiments of the present disclosure provide a novel interaction solution for video social applications. This solution can mine more preference information on the second user side to increase the degree of interaction between the first user and the second user, and also enables the first user to find more creators or uploaders of the audio of the video when watching the video, thereby significantly improving the user experience.

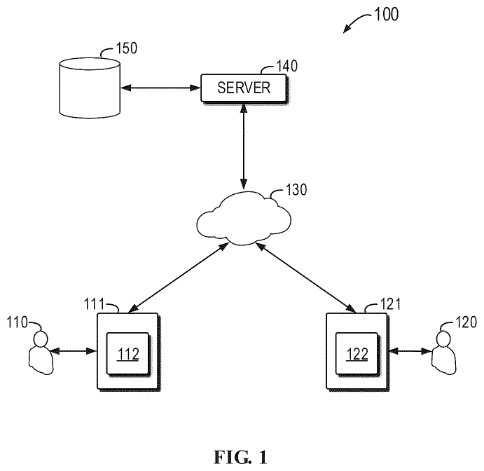

FIG. 1 illustrates a schematic diagram of an example environment 100 in accordance with embodiments of the present disclosure in which devices and/or processes according to embodiments of the present disclosure may be implemented. As shown in FIG. 1, example environment 100 may include a first user 110, a second user 120, first user equipment 111, second user equipment 121, first user interface 112, second user interface 122, network 130, a server 140, and storage 150.

In FIG. 1, the first user equipment 111 and the second user equipment 121 are respectively communicatively connected to the network 130, and the network 130 is communicatively connected to the server 140, thereby forming a communication connection between the user equipment and the server. The first user 110 interacts with the first user equipment 111 by the first user interface 112. As an example, the first user interface 112 may be touched or clicked by the first user 110, thereby receiving an instruction of the first user 110, and the first user interface 112 may be configured to display a corresponding video or a corresponding user operation interface to the first user 110, so as to realize the interaction between the user and the device. Similarly, the second user 120 interacts with the second user equipment 121 by the second user interface 122. As an example, the second user interface 122 may be touched or clicked by the second user 120 to receive an instruction of the second user 120, and the second user interface 122 may be configured to display a corresponding video or a corresponding user operation interface to the second user 120.

In some embodiments, the first user 110 may be a viewer watching a video played on a video social application, and the second user 120 may be an artist producing and uploading a video or an audio on the video social application.

In some embodiments, the first user equipment 111 and the second user equipment 121 may be any device with computing and communication capabilities. By way of non-limiting example, the first user equipment 111 and the second user equipment 121 may be any type of stationary computing device, mobile computing device, or portable computing device, including but not limited to mobile phones, desktop computers, laptop computers, notebook computers, netbooks computers, tablets, etc. Furthermore, in some embodiments, since the first user 110 and the second user 120 may be the same user, the first user equipment 111 and the second user equipment 121 may be the same user equipment.

In some embodiments, the server 140 may be any device with computing and communication capabilities. All or a portion of the components of server 140 may be distributed in the cloud. The server 140 and the nodes connected thereto may adopt a cloud-edge architecture.

In some embodiments, the storage 150 may be a storage medium for storing videos uploaded by the second user 120 through the second user equipment 121, including but not limited to, a hard disk (HDD), a solid state disk (SSD), removable disks, any other magnetic storage device and any other optical storage device, or any combination thereof.

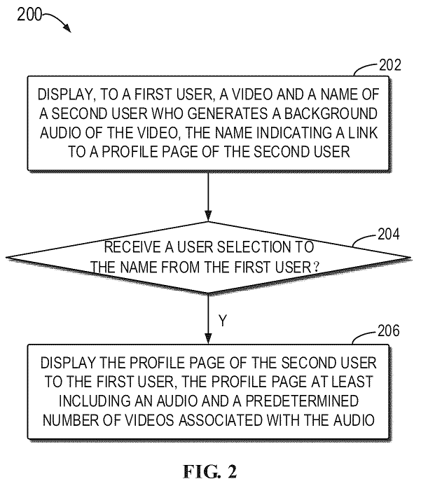

The specific form of interaction of the video social application arranged on the first user equipment 111 or the second user equipment 121 according to an embodiment of the present disclosure will be described in detail below with reference to FIG. 2. For ease of understanding, the specific data mentioned in the following description are all exemplary, and are not used to limit the protection scope of the present disclosure. It will be appreciated that the embodiments described below may also include additional acts not shown and/or may omit shown acts, and the scope of the present disclosure is not limited in this regard.

FIG. 2 illustrates a flowchart of a process 200 for displaying a profile page in accordance with an embodiment of the present disclosure. In some embodiments, process 200 may be implemented in first user equipment 111 or second user equipment 121 in FIG. 1. A process 200 for displaying a profile page in accordance with an embodiment of the present disclosure is now described with reference to FIG. 2. For ease of understanding, the specific examples mentioned in the following description are all illustrative, and are not intended to limit the protection scope of the present disclosure.

As shown in FIG. 2, at 202, a video and a name of a second user 120 who generates a background audio of the video are displayed to a first user 110. The name of the second user 120 may indicate a link to a profile page of the second user 120. In some embodiments, the second user 120 may comprise an artist, and the background audio of the video may comprise at least a piece of music.

And then, at 204, a detecting of a user input is continuously performed. If a user selection to the name from the first user 110 is detected, the process 200 proceeds to 206. That is, if the first user 110 clicks the name of the second user 120 on the video being displayed, move to 206.

At 206, the profile page of the second user is displayed to the first user. The profile page may at least include an audio and a predetermined number of videos associated with the audio. In some embodiments, after receiving the user selection to the name, the audio and the predetermined number of videos associated with the audio may be displayed directly in the profile page. Alternatively, after receiving the user selection to the name, the video tab of the profile page is presented first. Then, the predetermined number of videos associated with the audio will be displayed in the profile page after receiving a further user selection to the music/song tab.

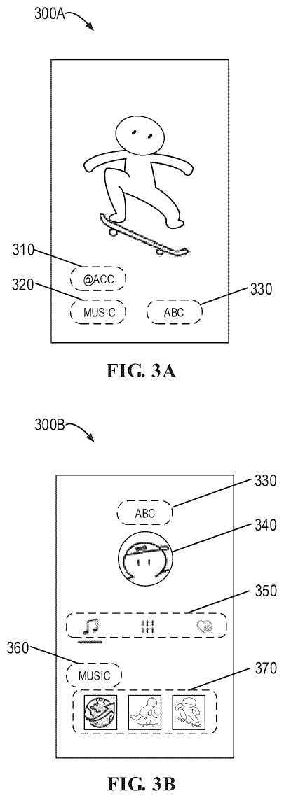

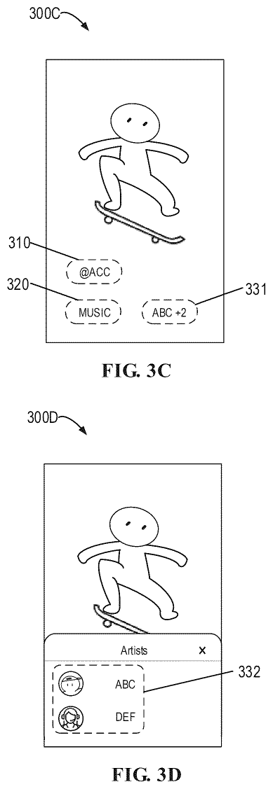

FIG. 3A illustrates a schematic diagram of a first state 300A of a user interface of a video social application according to an embodiment of the present disclosure. As shown in FIG. 3A, the first state 300A of the user interface may be displaying a video to the first user 110. In addition to the video itself, the first state 300A may further include the account name 310 of the user who uploads the video being displayed, the name 320 of the audio in the video, and the name 330 of the creator or uploader (i.e., the second user 120) of the audio. It will be appreciated that the name 330 of the second user 120 is the account name or ID of the user, and at least the region of the name 330 may be set to include a link to the profile page of the second user 120. As the name 330 of the second user 120 is arranged on the user interface of the embodiment of the present disclosure, the first user 110 may visit the profile page of the second user 120 directly through this link. For clarity of illustration, the first state 300A shown in FIG. 3A omits other locations where user input may be received, e.g., “like”, “comment”, and so on. FIG. 3A is for illustrative purposes only, and is not intended to limit the scope of protection of the present disclosure.

FIG. 3B illustrates a schematic diagram of a second state 300B of a user interface of a video social application according to an embodiment of the present disclosure. It will be appreciated that when the first user 110 clicks the region of the name 330 of the second user 120, then he/she will visit the profile page of the second user 120, which is shown in FIG. 3B. In FIG. 3B, the second state 300B of the user interface is displaying the profile page of the second user 120. The second state 300B may contain the name 330 of the second user 120 who is the creator or uploader of the audio, an avatar 340, a presentation selection area 350 (including music tags, video tags, etc.), the audio 360, and a plurality of videos 370 associated with the audio 360. For clarity of illustration, the second state 300B shown in FIG. 3B omits other locations where user input may be received, e.g., “like”, “comment”, and the like. FIG. 3B is for illustrative purposes only, and is not intended to limit the scope of protection of the present disclosure.

It should be understood that in addition to the audio 360, the profile page may also include a plurality of other audios, which may be selected by the second user 120 from their own portfolio, and each audio corresponds to a plurality of videos selected by the second user 120. In some embodiments, a predetermined number of videos are pre-pinned to the audio in the profile page by the second user 120. In this way, a video using the audio that is favored by the original artist of the audio may be more easily recommended to the wide range of users, thereby enhancing the interaction between the wide range of users and the original artist.

In some embodiments, when the video is displayed, the background audio generated by the second user 120 may be obtained from the video. As an example, the sound track may be extracted from the video as the background audio. The sound track may be examined at the server end to determine if the background audio of the video belongs to a predetermined audio database maintained in the storage 150. If so, the name of the second user 120 will be displayed together with the video, which means the producer or uploader of the audio has been verified. As an example, the background audio may be compared with audio in a predetermined audio database, and upon determining that the background audio matches an audio in the predetermined audio database by a predetermined threshold, it is determined to display the name of the second user 120. In this way, the PGC (Professionally Generated Content) and UGC (User Generated Content) modes can be effectively distinguished, so that the original author of the popular audio may be more easily recommended to the wide range of users.

In some embodiments, when the video is displayed, if the background audio of the video is generated by a plurality of users, a name of one of the plurality of users in the video will be displayed to the first user 110. As an example, the top user (or the most popular artist) may be displayed. FIG. 3C illustrated a schematic diagram of a third state 300C of a user interface of a video social application according to an embodiment of the present disclosure. As shown in FIG. 3C, the third state 300C of the user interface may be displaying a video to the first user 110. In addition to the video itself, the third state 300C may include the name 310 of the video being displayed, the name 320 of the audio in the video, and the names 331 of the creators or uploaders of the audio. As an example, the name 331 may also include the number of the user's name (“+2” in FIG. 3C).

And then, if the first user 110 clicks on the name of the top user, a group of names of the plurality of users will be displayed. FIG. 3D illustrates a schematic diagram of a fourth state 300D of a user interface of a video social application according to an embodiment of the present disclosure. As shown in FIG. 3D, the fourth state 300D of the user interface may be displaying to the first user 110 a list 332 of the above-mentioned plurality of users presented through a pull-up. In this way, a plurality of original artists of audios may be more easily recommended to the wide range of users.

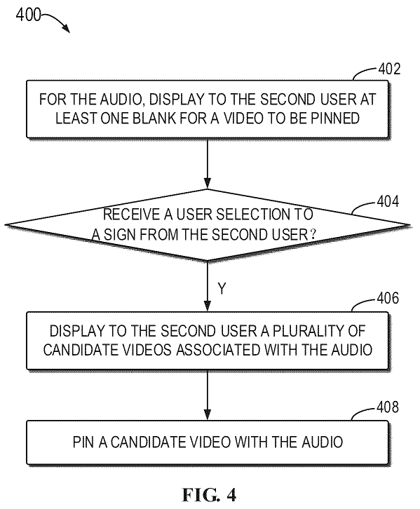

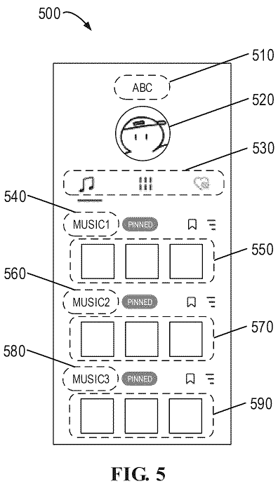

Next, a process of pinning a video according to an embodiment of the present disclosure will be described in detail with reference to FIG. 4. For ease of understanding, the specific data mentioned in the following description are all exemplary, and are not used to limit the protection scope of the present disclosure. It will be appreciated that the embodiments described below may also include additional acts not shown and/or may omit shown acts, and the scope of the present disclosure is not limited in this regard.

FIG. 4 illustrates a flowchart of a process 400 in which one or more videos selected by a second user (such as an artist) are pinned to audio uploaded by the artist, according to an embodiment of the present disclosure. In some embodiments, process 400 may be implemented in second user equipment 121 in FIG. 1. A process 400 for pinning video in accordance with an embodiment of the present disclosure is now described with reference to FIG. 4. For ease of understanding, the specific examples mentioned in the following description are all illustrative, and are not intended to limit the protection scope of the present disclosure.

As shown in FIG. 4, at 402, for the audio, at least one region for a video to be pinned is displayed to the second user 120. In order to illustrate this process more clearly, the setting operation interface of the second user 120 will now be described with reference to FIG. 5.

FIG. 5 illustrates a schematic diagram of a user interface 500 for an artist to perform an audio-video pinning operation according to an embodiment of the present disclosure. It should be understood that the audio-video pinning operation may be a user associating operation initiated by e.g. picking, clicking, selecting, or even the artist's voice command. It should also be understood that the user interface 500 is an editing interface for the profile page of the artist, which displays the name 510, the avatar 520 of the artist, a display selection area 530 (including a music tag, a video tag, a favorite tag), music/song 540 and the pinned videos 550, music/song 560 and the pinned videos 570, as well as music/song 580 and the pinned videos 590. As shown in FIG. 5, each music corresponds to a plurality of regions of blanks in the video, and these regions may be set by the artist to pin the corresponding music with the videos selected by the artist.

Continuing to refer to FIG. 4, at 404, a detecting of a user input is continuously performed. If a user selection to the sign of the at least one region from the second user 120 is detected, move to 406.

At 406, a plurality of candidate videos associated with the audio are displayed to the second user 120. And at 408, a candidate video may be pinned, e.g., with the audio. In this way, the second user 120 may determine the order of the self-created or uploaded audios in the profile page by editing his/her own profile page, and may further determine the favorite videos corresponding to some or all of the audios. It should be understood that these videos are usually videos that incorporate the audio composed by the second user 120 and are liked by the second user 120, so the second user 120 may enhance the interaction with other users through these settings.

In some embodiments, when a candidate video is pinned, if the second user 120 pins one of the plurality of candidate videos with the at least one region, the one video is pinned with the audio.

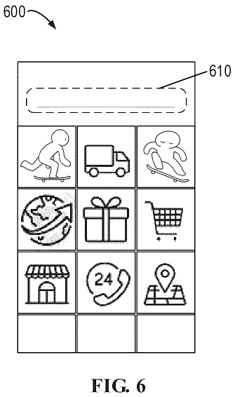

In some embodiments, when pinning a candidate video as above, a link of a candidate video to be pinned with the audio may be received from the second user 120. FIG. 6 illustrates a schematic diagram of a user interface 600 for an artist to perform an audio-video pinning operation by copying a video link, according to an embodiment of the present disclosure. As shown in FIG. 6, the user interface 600 contains a plurality of videos and a connected area 610 for entering a link of a video. It should be understood that the videos in the user interface 600 are usually composed with audios created or uploaded by the second user 120, and the second user 120 may pin a part of these videos to the corresponding video by copying the link of these videos or in other ways. Thereby, the second user 120 may easily display his/her favorite videos corresponding to the audio created or uploaded in his/her own profile page.

Additionally or alternatively, when a candidate video pinned, a background audio from the candidate video is compared with the audio. If the background audio from the candidate video is at least partially equivalent to the audio, the candidate video is pinned with the audio. Otherwise, an alert is displayed to indicate the video of the link does not have a same or similar background with the audio.

In some embodiments, the number of the pinned videos is being monitored during the pinning process. If the number of the pinned videos is greater than or equal to the predetermined number (maybe two or more), the displaying of the at least one region may be stopped, that is no region for more pinning.

In some embodiments, when the profile page is displayed, the predetermined number of videos from a plurality of videos in a music detail page may be generated based on a number of plays or clicks. The music detail page may be associated with the audio. That is, if the second user does not bind a favorite video, multiple videos can be automatically bound according to the number of plays or clicks. And then, the profile page is displayed with the audio and the predetermined number of videos.

In some embodiments, if the first user 110 selects one of the predetermined number of videos, a first video associated with the audio will be displayed to the first user 110. Furthermore, if the first user 110 swipes the first video, a second video associated with the audio will be displayed to the first user 110.

It should be understood that when the profile page of the second user 120 is displayed, there may be various display manners. As an example, when the profile page is displayed, a plurality of audios generated by the second user 120 may be displayed on the profile page, and the plurality of audios may include the audio. In other words, when the first user 110 clicks on the name of the second user 120 in the video, the profile page presented to the first user 110 directly displays the audio work of the second user 120. Thus, the first user 110 may conveniently view the audio work of the second user 120 and the video bound by the second user 120, thereby enhancing the interaction between the first user 110 and the second user 120.

As an example, when the profile page is displayed, a plurality of videos uploaded by the second user 120 may be displayed on the profile page. If the first user 110 selects to an audio tag, the plurality of audios generated by the second user 120 will be displayed on the profile page. Thereby, the interaction between the first user 110 and the second user 120 can also be enhanced.

Through the above embodiments, the present disclosure creates a novel interactive way of video social applications. In this interactive mode, by pinning one or more videos selected by the artist to the audio works displayed on the profile page of the artist, other users may more easily know the preferences of the artist, and the artist may also select their favorite videos to interact with video producers to enhance the user experience.

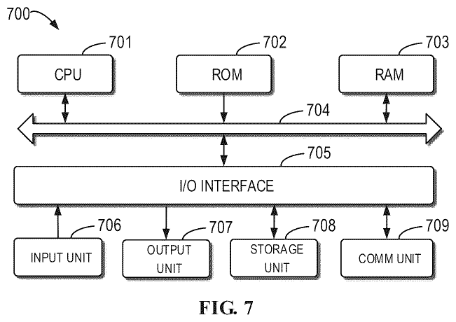

FIG. 7 illustrates a block diagram of an example device 700 that can be used to implement embodiments of the present disclosure. For example, the computing device 130 shown in FIG. 1 may be implemented by the device 700. As shown in the figure, the device 700 comprises a central processing unit (CPU) 701 that may perform various appropriate actions and processing based on computer program instructions stored in a read-only memory (ROM) 702 or computer program instructions loaded from a storage unit 708 to a random access memory (RAM) 703. In the RAM 703, there further store various programs and data needed for operations of the device 700. The CPU 701, ROM 702 and RAM 703 are connected to each other via a bus 704. An input/output (I/O) interface 705 is also connected to the bus 704.

Various components in the device 700 are connected to the I/O interface 705, comprising: an input unit 706 such as a keyboard, a mouse and the like; an output unit 707 comprising various kinds of displays and a loudspeaker, etc.; a storage unit 708 comprising a magnetic disk, an optical disk, and etc.; a communication unit 709 comprising a network card, a modem, and a wireless communication transceiver, etc. The communication unit 709 allows the device 700 to exchange information/data with other devices through a computer network such as the Internet and/or various kinds of telecommunications networks. It should be understood that in the present disclosure the output unit 707 may be used to display real-time dynamic change information of the user satisfaction degree, key factor recognition information of group users or individual users with the satisfaction degree, optimization policy information, and policy implementation effect evaluation information.

The processing unit 701 may be implemented through one or more processing circuits. The processing unit 701 may be configured to perform various processes and processing described above, for example, processes 200 and/or 400. For example, in some embodiments, the processes 200 and/or 400 may be implemented as a computer software program that is tangibly included in a machine readable medium, e.g., the storage unit 708. In some embodiments, part or all of the computer programs may be loaded and/or mounted onto the device 700 via ROM 702 and/or communication unit 709. When the computer program is loaded to the RAM 703 and executed by the CPU 701, one or more steps of the methods 300, 400 and/or 500 as described above may be executed.

The present disclosure may be a system, a method and/or computer program product. The computer program product may include a computer readable storage medium on which computer readable program instructions for executing various aspects of the present disclosure are embodied.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processing unit of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single implementation. Conversely, various features that are described in the context of a single implementation may also be implemented in multiple embodiments separately or in any suitable sub-combination.

Some example embodiments of the present disclosure are listed below.

In one aspect, there is provided a computer-implemented method. The method comprises: displaying, to a first user, a video and a name of a second user who generates a background audio of the video, the name indicating a link to a profile page of the second user; and in response to receiving a user selection to the name from the first user, displaying the profile page of the second user to the first user, the profile page at least including an audio and a predetermined number of videos associated with the audio.

In some embodiments, wherein the predetermined number of videos are pre-pinned to the audio in the profile page by the second user.

In some embodiments, the method further comprises: for the audio, displaying to the second user at least one region for a video to be pinned; in response to receiving a user selection to a sign of the at least one region from the second user, displaying to the second user a plurality of candidate videos associated with the audio; and pinning a candidate video.

In some embodiments, wherein pinning a candidate video comprises: in response to receiving a user pinning operation of one of the plurality of candidate videos with the at least one region from the second user, pinning the one video with the audio.

In some embodiments, wherein pinning a candidate video comprises: receiving a link of a candidate video to be pinned with the audio from the second user.

In some embodiments, wherein pinning a candidate video further comprises: comparing a background audio from the candidate video with the audio; and in response to the background audio from the candidate video being at least partially equivalent to the audio, pinning the candidate video with the audio.

In some embodiments, the method further comprises: in response to a number of the pinned videos being greater than or equal to the predetermined number, stopping the displaying of the at least one region.

In some embodiments, wherein displaying the video comprises: obtaining the background audio generated by the second user from the video; and in response to the background audio being stored in a predetermined audio database, displaying the name of the second user together with the video.

In some embodiments, wherein displaying the video comprises: in response to the background audio of the video being generated by a plurality of users, displaying a name of one of the plurality of users in the video; and in response to receiving a user input for clicking on the name of the one, displaying a group of names of the plurality of users.

In some embodiments, wherein displaying the profile page comprises: generating the predetermined number of videos from a plurality of videos in a music detail page based on a number of plays or clicks, the music detail page being associated with the audio; and displaying the profile page with the audio and the predetermined number of videos.

In some embodiments, wherein displaying the profile page comprises: displaying a plurality of audios generated by the second user on the profile page, the plurality of audios including the audio.

In some embodiments, wherein displaying the profile page further comprises: displaying a plurality of videos uploaded by the second user on the profile page; and in response to receiving a user selection to an audio tag from the first user, displaying the plurality of audios generated by the second user on the profile page.

In some embodiments, wherein the second user comprises an artist, and the background audio of the video comprises at least a piece of music.

In another aspect, there is provided an electronic device. The electronic device comprises a processing unit and a memory coupled to the processing unit and storing instructions thereon. The instructions, when executed by the processing unit, perform acts comprising: displaying, to a first user, a video and a name of a second user who generates a background audio of the video, the name indicating a link to a profile page of the second user; and in response to receiving a user selection to the name from the first user, displaying the profile page of the second user to the first user, the profile page at least including an audio and a predetermined number of videos associated with the audio.

In some embodiments, wherein the predetermined number of videos are pre-pinned to the audio in the profile page by the second user.

In some embodiments, the acts further comprises: for the audio, displaying to the second user at least one region for a video to be pinned; in response to receiving a user selection to a sign of the at least one region from the second user, displaying to the second user a plurality of candidate videos associated with the audio; and pinning a candidate video with the audio.

In some embodiments, wherein pinning a candidate video comprises: in response to receiving a user pinning operation of one of the plurality of candidate videos with the at least one region from the second user, pinning the one video with the audio.

In some embodiments, wherein pinning a candidate video comprises: receiving a link of a candidate video to be pinned with the audio from the second user.

In some embodiments, wherein pinning a candidate video further comprises: comparing a background audio from the candidate video with the audio; and in response to the background audio from the candidate video being at least partially equivalent to the audio, pinning the candidate video with the audio.

In some embodiments, the acts further comprises: in response to a number of the pinned videos being greater than or equal to the predetermined number, stopping the displaying of the at least one region.

In some embodiments, wherein displaying the video comprises: obtaining the background audio generated by the second user from the video; and in response to the background audio being stored in a predetermined audio database, displaying the name of the second user together with the video.

In some embodiments, wherein displaying the video comprises: in response to the background audio of the video being generated by a plurality of users, displaying a name of one of the plurality of users in the video; and in response to receiving a user input for clicking on the name of the one, displaying a group of names of the plurality of users.

In some embodiments, wherein displaying the profile page comprises: generating the predetermined number of videos from a plurality of videos in a music detail page based on a number of plays or clicks, the music detail page being associated with the audio; and displaying the profile page with the audio and the predetermined number of videos.

In some embodiments, wherein displaying the profile page comprises: displaying a plurality of audios generated by the second user on the profile page, the plurality of audios including the audio.

In some embodiments, wherein displaying the profile page further comprises: displaying a plurality of videos uploaded by the second user on the profile page; and in response to receiving a user selection to an audio tag from the first user, displaying the plurality of audios generated by the second user on the profile page.

In some embodiments, wherein the second user comprises an artist, and the background audio of the video comprises at least a piece of music.

In a further aspect, there is provided a computer program product. The computer program product is stored in a non-transitory computer storage medium and comprises machine-executable instructions. The instructions, when executed on a device, cause the device to perform acts comprising: displaying, to a first user, a video and a name of a second user who generates a background audio of the video, the name indicating a link to a profile page of the second user; and in response to receiving a user selection to the name from the first user, displaying the profile page of the second user to the first user, the profile page at least including an audio and a predetermined number of videos associated with the audio.

In some embodiments, wherein the predetermined number of videos are pre-pinned to the audio in the profile page by the second user.

In some embodiments, the acts further comprises: for the audio, displaying to the second user at least one region for a video to be pinned; in response to receiving a user selection to a sign of the at least one region from the second user, displaying to the second user a plurality of candidate videos associated with the audio; and pinning a candidate video with the audio.

In some embodiments, wherein pinning a candidate video with the audio comprises: in response to receiving a user pinning operation of one of the plurality of candidate videos with the at least one region from the second user, pinning the one video.

In some embodiments, wherein pinning a candidate video comprises: receiving a link of a candidate video to be pinned with the audio from the second user.

In some embodiments, wherein pinning a candidate video further comprises: comparing a background audio from the candidate video with the audio; and in response to the background audio from the candidate video being at least partially equivalent to the audio, pinning the candidate video with the audio.

In some embodiments, the acts further comprises: in response to a number of the pinned videos being greater than or equal to the predetermined number, stopping the displaying of the at least one region.

In some embodiments, wherein displaying the video comprises: obtaining the background audio generated by the second user from the video; and in response to the background audio being stored in a predetermined audio database, displaying the name of the second user together with the video.

In some embodiments, wherein displaying the video comprises: in response to the background audio of the video being generated by a plurality of users, displaying a name of one of the plurality of users in the video; and in response to receiving a user input for clicking on the name of the one, displaying a group of names of the plurality of users.

In some embodiments, wherein displaying the profile page comprises: generating the predetermined number of videos from a plurality of videos in a music detail page associated with the audio based on a number of plays or clicks; and displaying the profile page with the audio and the predetermined number of videos.

In some embodiments, wherein displaying the profile page comprises: displaying a plurality of audios generated by the second user on the profile page, the plurality of audios including the audio.

In some embodiments, wherein displaying the profile page further comprises: displaying a plurality of videos uploaded by the second user on the profile page; and in response to receiving a user selection to an audio tag from the first user, displaying the plurality of audios generated by the second user on the profile page.

In some embodiments, wherein the second user comprises an artist, and the background audio of the video comprises at least a piece of music.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
displaying, to a first user, a video and a name of a second user who generates a background audio of the video, the name indicating a link to a profile page of the second user; and
in response to receiving a user selection to the name from the first user, displaying the profile page of the second user to the first user, the profile page at least including an audio and a predetermined number of videos associated with the audio.

2. The method according to claim 1, wherein the predetermined number of videos are pre-pinned to the audio in the profile page by the second user.

3. The method according to claim 1, further comprising:
for the audio, displaying to the second user at least one region for a video to be pinned;
in response to receiving a user selection to a sign of the at least one region from the second user, displaying to the second user a plurality of candidate videos associated with the audio; and
pinning a candidate video.

4. The method according to claim 3, wherein pinning a candidate video comprises:
in response to receiving a user associating operation of one of the plurality of candidate videos with the at least one region from the second user, pinning the one video with the audio.

5. The method according to claim 3, wherein pinning a candidate video comprises:
receiving a link of a candidate video to be pinned with the audio from the second user.

6. The method according to claim 5, wherein pinning a candidate video further comprises:
comparing a background audio from the candidate video with the audio; and
in response to the background audio from the candidate video being at least partially equivalent to the audio, pinning the candidate video with the audio.

7. The method according to claim 3, further comprising:
in response to a number of the pinned videos being greater than or equal to the predetermined number, stopping the displaying of the at least one region.

8. The method according to claim 1, wherein displaying the video comprises:
obtaining the background audio generated by the second user from the video; and
in response to the background audio being stored in a predetermined audio database, displaying the name of the second user together with the video.

9. The method according to claim 1, wherein displaying the video comprises:
in response to the background audio of the video being generated by a plurality of users, displaying a name of one of the plurality of users in the video; and
in response to receiving a user input for clicking on the name of the one, displaying a group of names of the plurality of users.

10. The method according to claim 1, wherein displaying the profile page comprises:
generating the predetermined number of videos from a plurality of videos in a music detail page based on a number of plays or clicks, the music detail page being associated with the audio; and
displaying the profile page with the audio and the predetermined number of videos.

11. The method according to claim 1, wherein displaying the profile page comprises:
displaying a plurality of audios generated by the second user on the profile page, the plurality of audios including the audio.

12. The method according to claim 11, wherein displaying the profile page further comprises:
displaying a plurality of videos uploaded by the second user on the profile page; and
in response to receiving a user selection to an audio tag from the first user, displaying the plurality of audios generated by the second user on the profile page.

13. The method according to claim 1, wherein the second user comprises an artist, and the background audio of the video comprises at least a piece of music.

14. An electronic device, comprising:
a processing unit;
a memory coupled to the processing unit and storing instructions thereon, the instructions, when executed by the processing unit, performing acts comprising:
displaying, to a first user, a video and a name of a second user who generates a background audio of the video, the name indicating a link to a profile page of the second user; and
in response to receiving a user selection to the name from the first user, displaying the profile page of the second user to the first user, the profile page at least including an audio and a predetermined number of videos associated with the audio.

15. The device according to claim 14, the acts further comprising:
for the audio, displaying to the second user at least one region for a video to be pinned;
in response to receiving a user selection to a sign of the at least one region from the second user, displaying to the second user a plurality of candidate videos associated with the audio; and
pinning a candidate video.

16. The device according to claim 15, wherein pinning a candidate video comprises:
in response to receiving a user associating operation of one of the plurality of candidate videos with the at least one region from the second user, pinning the one video with the audio.

17. The device according to claim 15, wherein pinning a candidate video comprises:
receiving a link of a candidate video to be pinned with the audio from the second user.

18. The device according to claim 17, wherein pinning a candidate video further comprises:
comparing a background audio from the candidate video with the audio; and
in response to the background audio from the candidate video being at least partially equivalent to the audio, pinning the candidate video with the audio.

19. A computer program product stored in a non-transitory computer storage medium and comprises machine-executable instructions which, when executed on a device, cause the device to perform acts comprising:
displaying, to a first user, a video and a name of a second user who generates a background audio of the video, the name indicating a link to a profile page of the second user; and
in response to receiving a user selection to the name from the first user, displaying the profile page of the second user to the first user, the profile page at least including an audio and a predetermined number of videos associated with the audio.

20. The computer program product according to claim 19, the acts further comprising:
for the audio, displaying to the second user at least one region for a video to be pinned;
in response to receiving a user selection to a sign of the at least one region from the second user, displaying to the second user a plurality of candidate videos associated with the audio; and
pinning a candidate video.
